(19) United States
(12) Patent Application Publication
(10) Pub. No.: US 2024/0222999 A1
(43) Pub. Date: Jul. 4, 2024

(54) Battery Voltage Translator

(71) Applicant: Smartville, Inc., Carlsbad, CA (US)

(72) Inventors: William von Novak, Carlsbad, CA (US); Quiana Stodder, Carlsbad, CA (US)

(21) Appl. No.: 18/404,557

(22) Filed: Jan. 4, 2024

Related U.S. Application Data
(60) Provisional application No. 63/436,952, filed on Jan. 4, 2023.

(51) Int. Cl. H02J 7/02; H02J 7/00; H02M 3/156

(52) U.S. Cl. CPC H02J 7/02; H02J 7/00045; H02J 7/0014; H02J 7/0029; H02M 3/156; H02J 2207/20; H02J 2207/40

(57) ABSTRACT

A power storage system comprising a protocol translator and a bidirectional, fixed-ratio, direct-current/direct-current (DC/DC) converter. Optionally, the protocol translator converts the battery's unique reports to a more universal format, allowing compatibility with many inverter/chargers or with energy system controllers.

### RELATED APPLICATION

This application claims the benefit of priority from U.S. Provisional Patent Application No. 63/436,952 filed Jan. 4, 2023.

### FIELD OF THE INVENTION

This application relates generally to the field of batteries, specifically, for small to medium scale off-and on-grid, distributed generation power systems.

### BACKGROUND OF THE INVENTION

Power storage provides an essential function for both off-grid power systems and on-grid hybrid power systems. Distributed generation—primarily wind and solar—are intermittent, and demand-response systems (systems that can alter their demand based on grid load) both benefit from storage to allow intermittent supply to match often-asynchronous intermittent load. Being able to use a wide variety of storage systems helps with this goal.

Initially, off-grid power systems were based on 12-volt (12V) batteries, since that is both a common voltage for vehicles (including recreational vehicles) and lead acid batteries. Due to the easy availability of 12V batteries (arranged as 6 2-volt cells), early off-grid systems were based on very large 12V batteries.

As off-grid systems grew in size, and as on-grid hybrid systems for residential and commercial purposes became more common, 12V storage systems became problematic. A typical residence uses about 24 kilowatt-hours a day, and can see peaks of 4 kW with air conditioning and pool pump power draws. 4 kilowatts at 12 volts requires wiring that can handle ˜350 amps, and that is both expensive and subject to loss or drain due to wire resistance.

For decades telecom systems have used −48 volts as their line voltage for subscriber loops (standard wireline telephone service.) This meant that there was a moderately large assortment of battery chargers available for 48-volt batteries.

These two factors resulted in 48 volts becoming the new medium-power standard. This brings maximum currents down to 83 amps, which is within the range of ordinary residential wiring. 48 volts can be provided via 24 2-volt lead acid cells, 16 3.2-volt LFP cells or 13 3.6-volt lithium-ion cells, and thus batteries at this voltage are relatively easy to construct.

At the same time, 400-volt batteries are becoming an alternative, both because of the dramatically lower currents required for a given power output, and because EV batteries are tending towards this voltage. Thus, second-life use of EV batteries can provide a cheap source of battery storage for off-grid, residential on-grid and commercial on-grid energy systems.

A recent innovation in battery/inverter/charger integration is battery management system (BMS) communications. The BMS includes a substantial amount of information about the health and state of charge of the battery. Some newer inverter/chargers will interface with this BMS system and use a communications interface to determine things like the state of charge of the battery, which is useful when trying to manage energy in a complete system.

Another recent innovation is the use of all-in-one inverter/chargers that combine the functions of off-grid inverter, grid tie inverter, solar charge controller and battery charger all within one device. This allows easier integration with batteries, since only one battery and a single current protection device is needed.

As these three standard voltages have proliferated, standards problems have arisen.

Manufacturers of inverters, chargers and monitors for these three voltages have something of a dilemma. To provide adequate power at 12 volts, very large conductors, and large-area silicon switches, are needed to deal with the high currents. At the same time, 400-volt systems require silicon switches with high voltage standoffs to handle the voltages. Presently, there is a stark tradeoff between high current and high voltage switches, and thus it is not practical to handle power at both 400 volts and at the current needed for adequate 12-volt operation.

As a result of this, inverter/charger manufacturers choose a voltage and remain commercially devoted to that selection. The choice of voltage (and corresponding assumptions about current) dictates everything from circuit breaker size to wiring gauges to inductor size to selection of silicon switches for power conversion. Thus, there are specific equipment categories for each voltage.

This presents a problem for system integrators, especially integrators who need to work with legacy equipment. It is currently very difficult, for example, to retrofit a 48-volt, off-grid system with 400-volt, second-life EV batteries. The voltages are simply incompatible with one another, and, thus, the expensive and very difficult replacement of both the inverter and charge controller (or alternatively the batteries) become necessary.

The state of the art is sorely lacking in terms of viable options for power storage systems and this invention, by allowing use of many different batteries with a single hybrid inverter/charger, helps provide realistic solutions to the problems in the art.

### SUMMARY OF THE INVENTION

The present invention provides a power storage system comprising a protocol translator and a bidirectional, fixed-ratio, direct-current/direct-current (DC/DC) converter. Preferably, the system allows use of a battery with an inverter/charger that is incompatible in voltage. Most preferably, reported battery voltages and currents are changed within the protocol translator by a specific ratio or a specific procedure to make the battery appear to the inverter/charger to be the correct voltage and current for that inverter/charger. Preferably, the protocol translator performs basic functions selected from the group consisting of battery balancing and safety shutdown by acting directly on reported voltages and currents, rather than translating them first. Most preferably, the actual battery voltage is transformed by the bidirectional, fixed-ratio, converter such that it allows normal operation of the inverter/charger. Optionally, the protocol translator converts the battery's unique reports to a more universal format, allowing compatibility with many inverter/chargers or with energy system controllers.

In one aspect, the present invention provides for a system comprising a protocol translator that allows use of a battery with an inverter/charger that is incompatible in voltage. Preferably, the protocol translator converts the battery's unique reports to a more universal format, allowing compatibility with many inverter/chargers or with energy system controllers.

### BRIEF DESCRIPTION OF THE DRAWINGS

The novel features of the present invention are set forth herein embodied in the form of the claims of the invention. Features and advantages of the present invention may be best understood by reference to the following detailed description of the invention, setting forth illustrative embodiments and preferred features of the invention, as well as the accompanying drawings, of which:

FIG. 1 shows a standard application of the preferred system of the present invention comprising the bidirectional, fixed-ratio, direct-current/direct-current (DC/DC) converter and protocol converter.

FIG. 2 exemplifies the special case where the battery is the same voltage but different chemistry/cell count.

### DETAILED DESCRIPTION OF THE INVENTION

Described herein are methods, devices and systems specifically configured to allow for different voltage batteries to function with inverters/chargers that are at a different voltage than for which they were originally designed. It allows, for example, a 48-volt inverter/charger to register or “see” a 400-volt battery as if it were a 48-volt battery. Thus, no change in wiring, programming or protection devices on the inverter/charger is necessary.

This solution is accomplished by two separate elements that, optionally, work together in the preferred system of the present invention. The first is a bidirectional fixed ratio converter (BFRC), which is a DC/DC converter that does not use a feedback look to regulate input or output voltage, can convert in both directions, and can convert with very high efficiency. The second is a protocol translator, one that can translate the battery communications to make it appear to the inverter like it is working with the battery it expects.

### Bidirectional Fixed Ratio Converter

The BFRC is the power conversion element of the systems of the present invention. An exemplary approach would be to utilize a set of traditional buck/boost converters. This type of converter can, for example, take the 12 volts from a legacy battery and boost it to 48 volts for use with a modern 48V inverter. However, control for this type of manipulation is notoriously difficult. One issue is that the system would need two converters—one 12V to 48V to power loads, and one 48V to 12V to be used during battery charging. Thus, there would need to be some intelligence to “deduce” that the system wants to charge or discharge the battery, and configure the system to execute accordingly.

Furthermore, ordinary switch-mode converters exhibit a negative impedance characteristic on the input side. In other words, they will draw more and more current as the input voltage drops. Many inverters and charge controllers will react poorly to this characteristic, since batteries present the opposite characteristic (ie. batteries present as a very positive impedance, since increased voltage results in greatly increased current).

The BFRC resolves both of the aforementioned problems known in the art. Since the BFRC is a fixed ratio, it reflects the impedance of the device to which it is connected. For example, if a 48-volt inverter/charger is connected to a 12-volt battery, the inverter/charger would see the battery impedance multiplied by 4. Accordingly, since a 12-volt battery has a significantly lower impedance than a similar energy 48-volt battery, the inverter/charger will see a familiar load. In addition, since the converter is inherently bidirectional, there is no need to deduce desired direction and then enable a converter. Furthermore, while an ordinary bidirectional switchmode converter can have control added in order to make them function similar to a BFRC, this is far from preferable, since it comes with a substantial increase in cost and fabrication complexity.

### Protocol Translator

Modern battery management systems (BMS) have communications ports that allow inverter/chargers to read the state of the battery to make decisions on items such as remaining energy, charge termination, low-energy alerts etc. Even if a BFRC successfully translates the voltage levels, the BMS will report an unexpected number of cells, unexpected remaining amp-hours and unexpected battery voltage.

Preferably, the protocol translator will intercept the communications bus (for example, a CAN bus) and perform a translation to make the battery appear to be what the inverter is expecting to observe. It will do this by scaling all quantities to the same ratio that the BFRC is operating.

By way of example, consider a lead acid 12V battery operating on a 48V inverter. The 12V battery's BMS reports that it has six cells, each about 2 volts, and that it is providing 80 amps of current. The protocol translator will take this information and, instead, issues a report to the inverter that it has 24 cells, each about 2 volts, and that it is providing 20 amps of current. The protocol converter may also report the state of these fictitious cells by making estimates based on the actual battery. For example, if the lowest cell in the series stack is reporting 2.05 volts, then the protocol converter will report that the bottom four cells in the stack are all reporting 2.05 volts. This will enable the inverter to “believe” that the battery pack is healthy, and will allow charging and discharging of the battery.

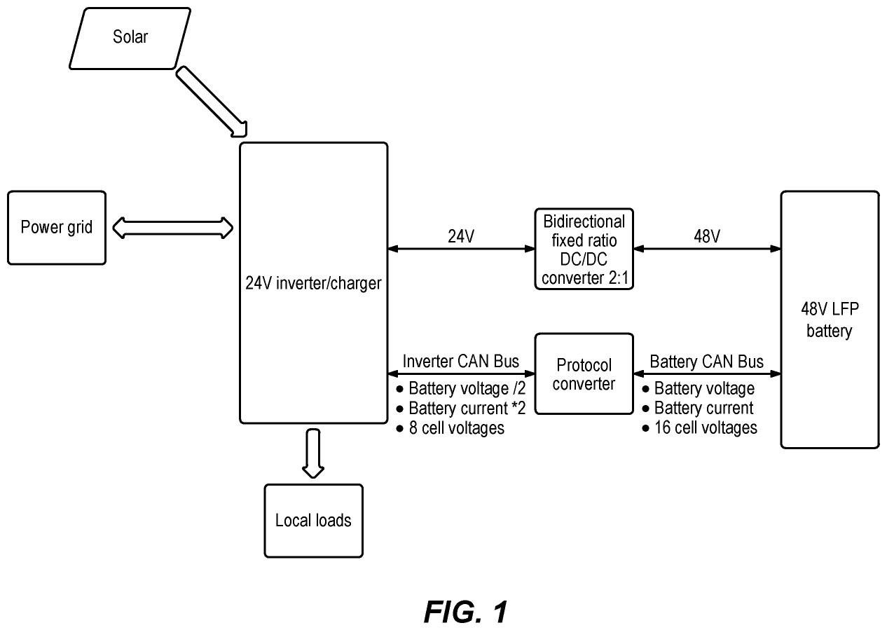

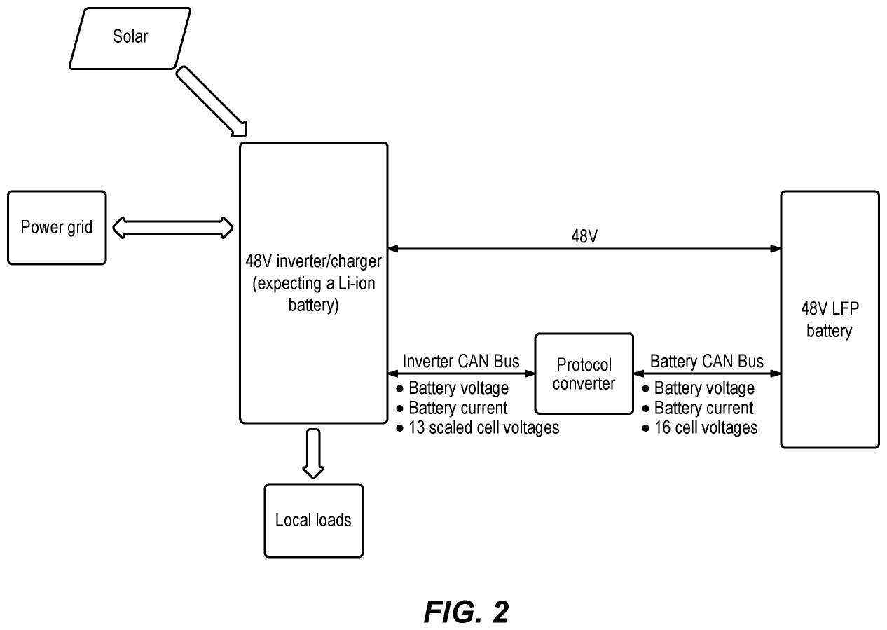

The topology of the preferred system of the present invention is shown at FIG. 1. In FIG. 1, a 24V inverter/charger (connected to the power grid, local backed up loads, and a solar array) is used with a 48V battery. The BFRC reduces the voltage from 48 to 24 volts, and the protocol translator reports a “fictional” number of cells, battery voltage and battery current to make the inverter/charger “believe” it is working with a 24V battery. FIG. 2 exemplifies the special case where the battery is the same voltage but different chemistry/cell count.

In preferred embodiments, the inverter/charger will be able to instantaneously pull a very large amount of current from the battery, for example, in the case of starting a compressor or other transient load. It may be impractical to size the BFRC to handle this large amount of current. In such cases, either a very small auxiliary battery, or a large capacitor, may be used to provide this temporary surge current. In both cases, the voltage rating of the capacitor/battery will match the expected voltage of the inverter/charger.

In certain alternative embodiments, the battery and BMS require an external controller to perform basic functions like balancing. Occasionally, this is performed by the inverter/charger itself, by commanding balancers within the battery to operate and keep the cells balanced. The above procedures (ie. such as reporting only 6 out of 24 cells) will NOT work with such a scheme, since the inverter/charger will see a fictional representation of the battery's cells, not the actual cell voltage values. In this case, the protocol translator will perform this function directly. For example, the protocol translator may observe cell voltages and, if any voltage is greater than the maximum charge voltage for that cell and specific chemistry, may enable a discharge resistor for that cell within the BMS. Any attempt by the inverter/charger to perform the same function is ignored and not passed on to the BMS by the protocol translator.

In further embodiments, the battery's operating range may be close enough to the operating range of the inverter/charger to make operation possible without a BFRC. When such a circumstance occurs, a system using the protocol translator alone may be sufficient. An example of this could be a 13S li-ion battery used with an inverter/charger expecting a 16S LFP battery. The voltage ranges are close enough to allow operation as long as the translator provides compatible BMS information to the inverter/charger.

Optionally, the protocol translator will translate the reports from the battery to a more universal format that can be used by many different inverters (or other system controllers) rather than a specific format required by a specific inverter. Often times, systems that incorporate batteries, inverters and chargers also have a system controller that manages power transfer at a higher level and, in such cases, a protocol translator that converts disparate battery reports to a universal format compatible with the system controller will be useful.

### Examples

Case 1 Study: Battery with Same Chemistry, Integer Division

The case where the original battery is the same chemistry is straightforward, since all values can be scaled by a simple ratio.

The basic formulas are as follows:

$$Ratio = Inverter expected nominal voltage / Battery \\ nominal voltage ( should always be rounded to an integer ) \qquad ( a )$$

$$\# reported cells = Ratio * actual cells \qquad ( b )$$

$$Reported per - cell voltage = voltage of single \\ cell duplicated ( Ratio ) times or decimated ( Ratio ) times \qquad ( c )$$

$$Reported battery voltage = Ratio * actual battery voltage \qquad ( d )$$

$$Reported battery current = Actual battery current / ratio \qquad ( e )$$

In this Case 1 example, a 12V inverter/charger is being used with a 48-volt battery. The BFRC performs a division by 4, so the battery voltage as seen by the inverter is 12 volts. 12/48 is ¼, so 3 out of every 4 cells are not reported. Instead of reporting the voltage of 24 cells, only 6 evenly spaced cells are reported. In this case, cells 1, 5, 9, 13, 17 and 21 would be reported as cells 1,2,3,4,5 and 6.

Battery voltages are reported as actual battery voltage divided by 4. Battery currents are reported as actual battery current multiplied by 4.

Case 2 Study: Battery with Same Chemistry, Non-Integer Division

In this case, since the number of cells cannot be easily divided into the new number, a different method must be used. A reported number of series cells is determined empirically, usually by looking at the number of cells the inverter/charger expects for that type of battery. Then a reported voltage is generated for each reported cell. In this case, each cell voltage is reported as (converted battery voltage/number of expected cells.) Reported battery voltage and battery current are derived by multiplying and dividing battery voltage and current by the actual ratio of the BFRC.

An alternative is that exemplary cells can be chosen empirically, for instance, by skipping every 7 or 8 cells, and then those can be reported as in Case 1. The example below does not use this option.

In this Case 2 example, A 48V inverter/charger, expecting a 13S li-ion battery, used with a 400V 96S li-ion EV battery.

In this example, there is no integer division possible. A division ration is chosen (7) that will give an acceptable voltage range. The inverter/charger expects a voltage range of 35.1 to 54.6 volts; a division by seven from 400V will give a 37 to 57.6 volt range, which should be within tolerances for most inverter/chargers (since they include some design margin.) Note that if this exceeds the voltage range of the inverter, a division by 8 is possible—but this example will assume a division by 7 is acceptable.

The voltage reported per cell will be total battery voltage/# of cells. This produces a voltage range of 2.85 to 4.43 volts. Since the inverter will assume that 4.43 volts is an overvoltage, an additional scaling factor of 95 is applied to reduce the voltage range to 2.7 to 4.2 volts per cell. The inverter/charger is now seeing a better replica of the cell voltages.

As before, battery voltage is reported as battery voltage divided by 7 and battery current is reported as battery current multiplied by 7.

Case 3 Study: Battery with Different Chemistry, Non-Integer Division

In this case, since the cell voltages may not scale easily (i.e. a 3.2 volt LFP cell vs a 3.6 volt lithium-ion cell) additional scaling and gain adjustment may be required.

In this Case 3 example, a 48V 13S lithium-ion battery is used with an inverter/charger expecting a 24V 8S LFP battery. BFRC ratio is divide by 2. An even division is not possible, so the Case 2 method from above is used (i.e. report 8 cells, each cell being reported as battery voltage/number of expected cells/divide ratio). This results in a reported cell voltage range of 2.19-3.41 volts. This is out of the legal range for LFP batteries, and may cause the inverter/charger to shut down for safety reasons.

First, a scaling factor of 1.15 is applied to raise the voltage range to 2.52-3.92 voltage. This results in the lower voltage being close to what the inverter expects, but the high voltage is far too high. Next, a second gain term is used, increasing or decreasing voltages for any voltage above the minimum of 2.41 volts. A gain term of −0.3 results in a reported cell voltage range of 2.52 to 3.5 volts. The inverter/charger now sees a range of voltages that it considers safe and acceptable. Note that, in this case, the li-ion range of 2.7 to 4.2 volts have been re-mapped to the LFP range of 2.5 to 3.2 volts. Also note that the battery is reporting that 2.7 to 4.2 volt range, and the protocol translator is translating that to a range of 2.5 to 3.2.

In certain, additional embodiments, the example ranges shown above may be adjusted to peculiarities of the inverter/charger. For example, if an inverter/charger seeks to limit any lithium-ion cell voltage to under 4.1 volts for safety reasons, the ratio can be adjusted such that 4.1 volts is reported when the actual battery is at full charge.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features. As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

We claim:

1. A power storage system comprising a protocol translator and a bidirectional direct-current/direct-current (DC/DC) converter, wherein the system allows use of a battery with an inverter/charger, wherein the battery is ordinarily incompatible with the inverter/charger with respect to voltage.

2. The system of claim 1, wherein battery voltages and currents are changed within the protocol translator by a specific ratio or a specific procedure to make the battery appear to the inverter/charger to be the correct voltage and current for the inverter/charger.

3. The system of claim 1, wherein the protocol translator performs at least one basic function selected from the group consisting of battery balancing and safety shutdown by acting directly on reported voltages and currents, rather than translating them first.

4. The system of claim 1, wherein the battery voltage is transformed by the bidirectional, fixed-ratio converter in order to allow normal operation of the inverter/charger.

5. The system of claim 1, wherein the protocol translator converts at least one unique report of the battery to a universal format.

6. A power storage system comprising a protocol translator, an inverter/charger and at least one battery, wherein the system allows use of the at least one battery with the inverter/charger, wherein the battery is incompatible in voltage with respect to the inverter/charger.

7. The system of claim 6, wherein the protocol translator converts unique reports of the battery to a universal format, thereby allowing compatibility with many inverter/chargers or with energy system controllers.
